(19) United States
(12) Patent Application Publication
(10) Pub. No.: US 2026/0131412 A1
(43) Pub. Date: May 14, 2026

(54) MACHINE TOOL FOR MANUFACTURING FLAT INSTRUMENTS AND/OR TOOLS AND METHOD FOR MANUFACTURING FLAT INSTRUMENTS AND/OR TOOLS FOR MEDICAL TECHNOLOGY USING SUCH A MACHINE TOOL

(71) Applicant: Schwäbische Werkzeugmaschinen GmbH, Schramberg-Waldmössingen (DE)

(72) Inventors: Damir VIDOVIC, St. Georgen (DE); Matthias Dreher, Wurmlingen (DE)

(21) Appl. No.: 19/382,434

(22) Filed: Nov. 7, 2025

(30) Foreign Application Priority Data
Nov. 8, 2024 (EP) 24211688.7

(51) Int. Cl. B23Q 1/54

(52) U.S. Cl. CPC B23Q 1/5406; B23Q 2240/002

(57) ABSTRACT

A machine tool for manufacturing flat instruments and/or tools for medical technology, including a machine frame, a working spindle, a workpiece table that can be assigned or is assigned to the working spindle and is mounted directly or indirectly on the machine frame about a table axis, and a workpiece holder which is fixed to the workpiece table and has a first workpiece receptacle to which a flat workpiece can be fixed for machining a flat side, and which has a second workpiece receptacle that runs transversely or obliquely to the first workpiece receptacle and to which a flat workpiece can be fixed for machining an end face. The workpiece table is accessible from a first working position and can be moved by rotating or swivelling about the table axis assigned to it into a second working position.

### CROSS-REFERENCE

This application claims the benefit of European application EP 24211688.7 filed Nov. 8, 2024, which is incorporated herein by reference.

Machine tool for the manufacture of flat instruments and/or tools for medical technology and processes for the manufacture of flat instruments and/or tools for medical technology with this type of machine tool.

It is known from the prior art to machine flat instruments and/or tools made from forged parts, so-called impact tools, ‘on the fly’ or ‘in a stationary position’. For the forged blanks, the production process includes many individual and also manual machining steps that could include manual belt grinding, for example, after the machining. During ‘stationary’ or ‘on the fly’ machining, it is often subject to very high vibrations. The production-related vibrations can reduce the quality of the finished instruments and/or tools, or a time and cost intensive post-processing of the individual instruments and/or tools can become necessary.

Furthermore, the constant re-clamping of the individual workpieces for the manufacture of the flat instruments and/or tools can require a lot of time and also reduces quality.

### SUMMARY

One task of an exemplary embodiment of the invention is to propose a machine tool for the manufacture of flat instruments and/or tools whereby the manufacturing duration and the product quality of the flat instruments and/or tools is reduced/improved.

This task is solved by a machine tool for manufacturing flat instruments and/or tools with a machine frame, with at least one working spindle that is mounted so that it can rotate around a spindle axis, with at least one workpiece table that can be assigned or is assigned to at least one working spindle and is mounted directly or indirectly on the machine frame so that it can rotate or swivel around a table axis, and with at least one workpiece holder which is fixed to the workpiece table, which has at least one first workpiece receptacle to which a flat workpiece can be fixed for machining a flat side, and which has at least one second workpiece receptacle, which runs transversely or obliquely to the first workpiece receptacle and to which a flat workpiece can be fixed for machining a front side, wherein at least one of the at least one workpiece table can be transferred from a first working position, in which the first workpiece receptacle is accessible to at least one of the at least one working spindle for machining, by rotating or swivelling about the table axis assigned to it into a second working position, in which the second workpiece receptacle is accessible to at least one of the at least one working spindle for machining.

As the machine tool includes a workpiece holder with a first workpiece receptacle and a second workpiece receptacle, a flat instrument and/or tool can be produced from a flat workpiece, wherein a maximum of 2 clamps are required.

As a flat workpiece can be fixed on the first workpiece receptacle for the machining of a flat face, the use of forged parts is not required and the flat instrument and/or tool that is to be manufactured can be milled from a solid material. The risk of the occurrence of vibrations when machining with the working spindle is greatly reduced when the workpiece is fixed in the first workpiece receptacle over a large area.

As the flat workpiece can be fixed in the second workpiece receptacle in order to machine a front side, and/or can be held in clamping jaws, this means that working areas of flat instruments and/or tools can be machined out of the flat workpiece.

The flat workpieces that can be fixed on the second workpiece receptacle can include workpieces that were previously fixed on the first workpiece receptacle and machined using the at least one drive spindle.

As the workpiece table can be transferred from the first work position into the second work position and back, the first workpiece receptacle and the second workpiece receptacle on the workpiece holder can be machined by one and the same working spindle.

In principle, the at least one workpiece table can be designed as required, as long as it fulfils its technical function to fix the workpiece holder. It proves advantageous if at least one of the at least one workpiece table has a holding surface on which at least one of the at least one workpiece holder is arranged and that, in the first working position, is arranged transversely or obliquely to the spindle axis of the working spindle assigned to the workpiece table, and that, in the second working position, is arranged transversely or obliquely to the spindle axis of the working spindle assigned to the workpiece table.

In a further development of the latter embodiment, it is provided that the first workpiece receptacle of the workpiece holder runs parallel or obliquely to the holding surface of the workpiece table and that the flat workpiece that is fixed on the first workpiece receptacle can be machined by the working spindle on its flat side running parallel or at an angle to the holding surface and/or that the second workpiece receptacle of the workpiece holder runs transversely or obliquely to the holding surface of the workpiece table and that the flat workpiece fixed on the second workpiece receptacle can be machined by the working spindle on its end face running transversely or obliquely to the holding surface.

As the first workpiece receptacle of the workpiece holder runs parallel or obliquely to the holding surface of the workpiece table, the first workpiece receptacle stands transversely or obliquely to the spindle axis of the working spindle if the workpiece table is in the first work position. In this case, the flat workpiece fixed to the first workpiece receptacle can rest against the workpiece holder with a contact surface parallel to the flat side that can be machined by the working spindle. This reduces the risk of the occurrence of vibrations when working the flat workpiece fixed to the first workpiece receptacle with the working spindle. This allows the machining quality to be improved.

As the second workpiece receptacle on the workpiece runs transversely or obliquely to the holding surface of the workpiece table, the flat tool fixed on the second workpiece receptacle can be machined in the second working position of the workpiece table using the working spindle. The end face of the workpiece can be machined by the working spindle in this case.

In one embodiment of the machine tool it is provided that the first workpiece receptacle is arranged on a head surface of the workpiece holder that runs parallel or obliquely to the holding surface and at a distance to the holding surface and that at least one of the at least one second workpiece receptacle is arranged on a side surface that is arranged between the holding surface and the head surface or that runs transversely or obliquely to the holding surface.

In this case, the workpiece holder can be designed as a tower or a block, wherein the first workpiece receptacle is arranged on an end surface facing away from the workpiece table and the at least one second workpiece receptacle extends from the first workpiece receptacle and the holding surface of the workpiece table.

In principle, it is conceivable that only a first workpiece receptacle and only a second workpiece receptacle are arranged on the workpiece holder. It proves advantageous if at least one of the at least one workpiece holder has at least two second workpiece receptacles, each of which runs transversely or obliquely to the first workpiece receptacle, and if the workpiece holder comprises at least one workpiece holder drive, by means of which the workpiece holder can be moved relative to the workpiece table, at least in the second working position of the workpiece table, from a first machining position, in which a first second workpiece receptacle is accessible to the working spindle, to at least one further machining position, in which a further second workpiece receptacle is accessible to the working spindle.

As the workpiece holder comprises at least two second workpiece receptacles, at least two workpieces can be arranged on the second workpiece receptacle and machined by the working spindle. The enables the reduction of machining times.

For example, it is conceivable that at least two further workpieces to be machined are produced from a workpiece fixed to the first workpiece holder by machining by the working spindle, which can then be arranged as individual workpieces on a second workpiece holder and machined there by the working spindle.

During the manufacture of instruments and/or tools for medical technology a plate-like workpiece can be arranged on the first workpiece receptacle, out of which one plug-in and one box part of a medical tool and/or instrument can be machined. These can be joined together to form a needle holder, which is assembled from these two aforementioned components.

Several workpiece sizes can be worked in this way without retooling. For each clamping position one plug-in and one box part can be arranged, making six clamping positions. This makes retooling between these variations unnecessary, saving time and costs and ensuring high quality.

In one embodiment of the machine tool, it proves advantageous if at least six second workpiece holders are arranged on the workpiece holder, distributed evenly in the circumferential direction around an axis extending transversely to the holding surface of the workpiece table by means of the workpiece holder.

If several second workpiece receptacles are provided on the workpiece holder, the workpiece holder can be transferred from a first machining position to a second machining position etc. The number of machining positions into which the workpiece holder can be transferred corresponds to the number of provided second workpiece receptacles.

In one embodiment of the machine tool it proves to be advantageous if at least one of the at least one workpiece holder is fixed to the holding surface of the workpiece table so that it can rotate about a workpiece holder axis of rotation extending transversely to the holding surface of the workpiece table.

As the workpiece holder can rotate about workpiece holder axis of rotation extending transversely to the holding surface of the workpiece table, the workpiece that is arranged on the first workpiece receptacle and/or the second workpiece receptacle can be better machined by the working spindle. For this, the workpiece on the first workpiece receptacle or the workpiece on the second workpiece receptacle is rotated relative to the working spindle.

In a further development of the latter embodiment, it proves advantageous if the transfer from the first machining position to the second machining position by the workpiece holder drive comprises rotating or swivelling of the workpiece holder about the workpiece holder axis of rotation.

In this case, the workpiece holder can be easily transferred from the first working position into the at least one further working position by rotation around the workpiece holder axis of rotation if more than a second workpiece receptacle is arranged on the workpiece holder.

It proves to be advantageous if at least one of the at least one first workpiece receptacles fixes a flat workpiece fixed to it for rough and semi-fine machining (OP 10) by the at least one working spindle and/or if at least one of the at least one second workpiece holder fixes a flat workpiece fixed to it for fine machining (OP 20) by the at least one working spindle.

This can ensure that the machining of the first workpiece receptacle differs from the machining on the second workpiece receptacle, thus enabling different stages of the manufacturing process for a flat instrument and/or tool to be carried out.

Embodiments of the machine tool are provided for which at least two workpiece holders are arranged on one workpiece table, arranged on the same holding surface at a distance from one another.

This allows an increase in the number of products that can be manufactured once the workpiece table has been loaded.

In a further development of the latter embodiment, it proves advantageous if the at least one working spindle comprises at least one first working spindle, which is assigned to a first workpiece holder of the at least two workpiece holders, and at least one further working spindle, which is assigned to a further workpiece holder of the at least two workpiece holders.

As the at least one working spindle comprises at least one first working spindle and at least one further working spindle, wherein each working spindle is assigned to a workpiece holder, the number of the products that can be manufactured per period can be increased.

In this case, the number of the working spindles can correspond to the number of workpiece holders that are assigned on the workpiece table on the same holding surface.

Furthermore, embodiments of the machine tool are conceivable with at least one workpiece holder arranged on a holding surface of a workpiece table and another at least one workpiece holder is arranged on the side of the workpiece table on a further holding surface facing away from the holding surface. In this case the workpiece table is not only transferred from the first working position to the second working position and back, but can also include a 180° rotation, so that the workpiece holder, which was previously at the rear, is then facing the working spindle.

In this configuration, it is also conceivable that two or more workpiece holders face the holding surface facing the working spindle and that at least two or more workpiece holders are arranged on the rear holding surface of the workpiece table facing away from the holding surface.

In order to reduce machining times, it proves to be advantageous if the at least one workpiece table comprises at least two workpiece tables, wherein a first workpiece table can be rotated or swivelled about a first table axis and a second workpiece table can be rotated or swivelled about a second table axis without touching the first workpiece table and wherein the first table axis and the second table axis run parallel to one another.
the number of the workpieces that can be loaded can be increased because at least two workpiece tables are provided with table axes that run parallel to one another.

For example, the at least two workpiece tables can both be fixed to the machine frame and arranged above or next to one another. If the table axes of the at least two workpiece tables run parallel to a horizontal axis, for example, then the table axes of the workpiece tables can be arranged vertically above one another. Furthermore, it is conceivable that the table axis of the at least two workpiece tables are arranged next to one another horizontally if the table axes run parallel to a vertical axis.

If at least two workpiece tables are provided it is conceivable, for example, that in a separated position, these separate a working area facing one of the at least one working spindle from a loading and unloading area facing away from one of the at least one working spindle. In this case it is conceivable, for example, that the workpiece holders of a first workpiece table are machined and thereby turned towards the working area and a workpiece table running parallel to this with its workpiece holder in the loading and unloading area. In this case, a workpiece table can be loaded and unloaded in parallel to machining time, while the workpieces are being machined by the working spindle on the other workpiece table. In this connection, it proves to be advantageous if the workpiece tables are designed in such a way that they screen off the working area from the loading and unloading area for operating personnel.

Furthermore, embodiments of the machine tool are conceivable in which the at least one workpiece table is mounted on a swivel support so that it can rotate or swivel, wherein the swivel support is fixed to the machine frame so that it can rotate or swivel on the machine frame about a swivel axis and can be moved from a first swivel position, in which at least one of the at least one workpiece table can be arranged in a working area facing the at least one working spindle, to a second swivel position, in which the workpiece table is arranged in a loading and unloading area.

This can simplify the loading and unloading of the machine tool.

In a further development of the latter embodiment it proves to be advantageous if the at least two workpiece tables are arranged on opposite sides of the swivel support, wherein at least one first workpiece table is arranged in the working area in the first swivel position of the swivel support and at least one second workpiece table is arranged in the loading and unloading area in the first swivel position of the swivel support loading and unloading area, and wherein the at least one first workpiece table is arranged in the loading and unloading area in the second swivel position of the swivel support and the at least one second workpiece table is arranged in the working area in the second swivel position of the swivel support.

As at least one first workpiece table is always arranged in the working area, which is machined by the at least one working spindle and as the at least one second workpiece table is arranged in the first swivel position of the swivel support in the loading and unloading area in this case, the at least one second workpiece table can be loaded and unloaded in parallel to machining time, while the workpieces arranged on at least one workpiece table are machined by the at least one working spindle.

Embodiments are conceivable in which several first workpiece tables are arranged on the swivel support, arranged in the first swivel position of the swivel support in the work area and several second workpiece tables that are arranged in the first swivel position of the swivel support in the loading and unloading area. These can be arranged above or next to one another.

Embodiments are conceivable in which the swivel support axis, the at least one first table axis and/or the at least one second table access runs or run parallel to a horizontal x-axis, and that run in particular parallel to one another or in which the swivel support axis, the at least one first table axis and/or the at least one second table axis runs or run parallel to a vertical y-axis and in particular that run parallel to one another.

Furthermore, embodiments of the machine tool are also conceivable in which the swivel support axis runs parallel to a vertical y-axis and the at least one first table axis and/or the at least one second table axis runs parallel to a horizontal x-axis. Conversely, it is also conceivable that, if the swivel support axis runs about an x-axis that runs parallel to the horizontal, the at least one first table axis and/or the at least one second table axis runs parallel to a vertical y-axis.

If more than a first table axis and a second table axis are provided then all table axis can run parallel to one another.

Finally, it proves advantageous if the first working spindle and the at least one further working spindle are arranged horizontally next to one another, if the at least one table axis, in particular the first table axis, runs parallel to the horizontal x-axis, and if the first working spindle and the at least one further working spindle are arranged vertically above one another, if the at least one table axis, in particular the first table axis, runs parallel to the vertical y-axis.

The number of working spindles can correspond to the number of workpiece holders in the working area.

Furthermore, the task is solved with a process for the manufacture of flat instruments and/or tools for medical technology with a machine tool with one of the abovementioned characteristics with the steps:
a. 100: Fixing of a flat workpiece on the at least one first workpiece receptacle;
b. 101: Fixing of at least one workpiece that has already been machined on the first workpiece receptacle to one of the at least one second workpiece receptacle;
c. 102: Transfer of the workpiece table into the first working position, in which the first workpiece receptacle of the at least one working
spindle is accessible for machining, and machining of the first workpiece fixed to the first workpiece receptacle by the working spindle;
d. 103: Transfer of the workpiece table into the second working position, in which the second workpiece receptacle of the at least one working spindle is accessible for machining, and machining of the second workpiece fixed to the second workpiece receptacle by the working spindle;
e. 104: If necessary Transfer of the workpiece holder from the first machining position to a further machining position;
f. 105: Removal of the at least one workpiece machined on the second workpiece receptacle and removal of the at least one workpiece machined on the first workpiece receptacle.

Step 104 can be carried out if necessary. This means that step 104 is not carried out if only one second workpiece receptacle is arranged on the workpiece holder. If several second workpiece receptacles are provided and workpieces to be machined are provided on each of these, step 104 must be carried out.

The workpieces that are arranged and machined on the first workpiece receptacle can be separated completely during machining and in step 105. This then allows them to be broken off manually or with a robot.

A transfer station can be used to then arrange and fix these parts on the second workpiece receptacles as workpieces that require further machining.

Further features, details and advantages of the invention are apparent from the appended patent claims, from the drawing and from the following description of a preferred embodiment of the machine tool.

### BRIEF DESCRIPTION OF THE DRAWINGS

The drawing shows:

FIG. 1 A schematic perspective representation of an embodiment of the machine tool according to the invention;

FIG. 2 An isometric detail view of a workpiece table with two workpiece holders arranged on it according to the exemplary embodiment in FIG. 1;

FIG. 3 A top view of the workpiece table with two workpiece holders arranged on it according to FIG. 2;

FIG. 4 A schematic flow chart of one embodiment of the process according to the invention.

### DETAILED DESCRIPTION

The figures show a machine tool for the manufacture of flat instruments and/or tools marked as a whole with reference number 2. The machine tool 2 includes a machine frame 4 and, in the exemplary embodiment in the figures, two working spindles 6. The working spindles 6 can each be rotated about a spindle axis 8.

In addition, the machine tool 2 comprises two workpiece tables 10 in the exemplary embodiment shown in the figures, are each mounted indirectly in the machine frame 4 to rotate and/or swivel about a table axis 12.

In the exemplary embodiment shown in the figures there are two workpiece holders 14 arranged on each workpiece table 10, each fixed to workpiece table 10.

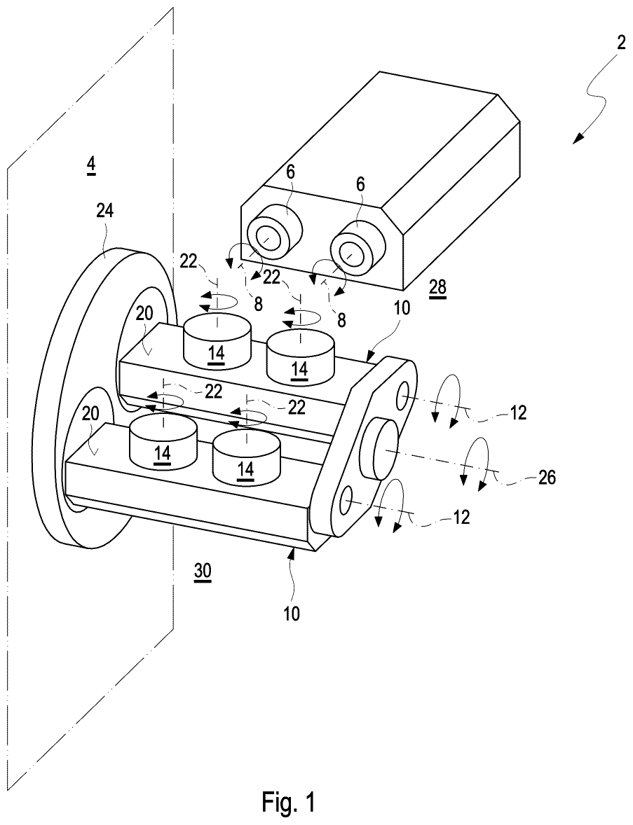

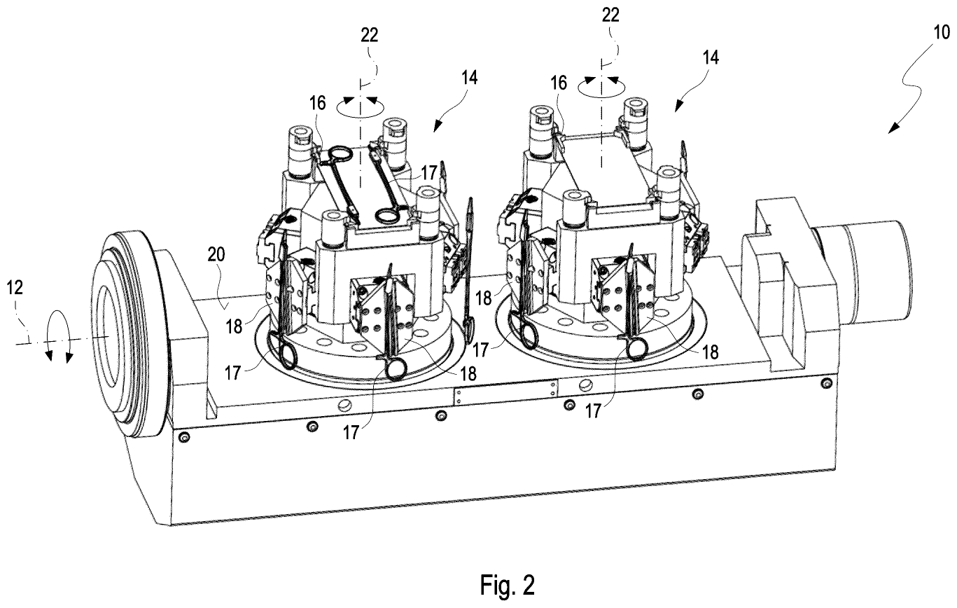

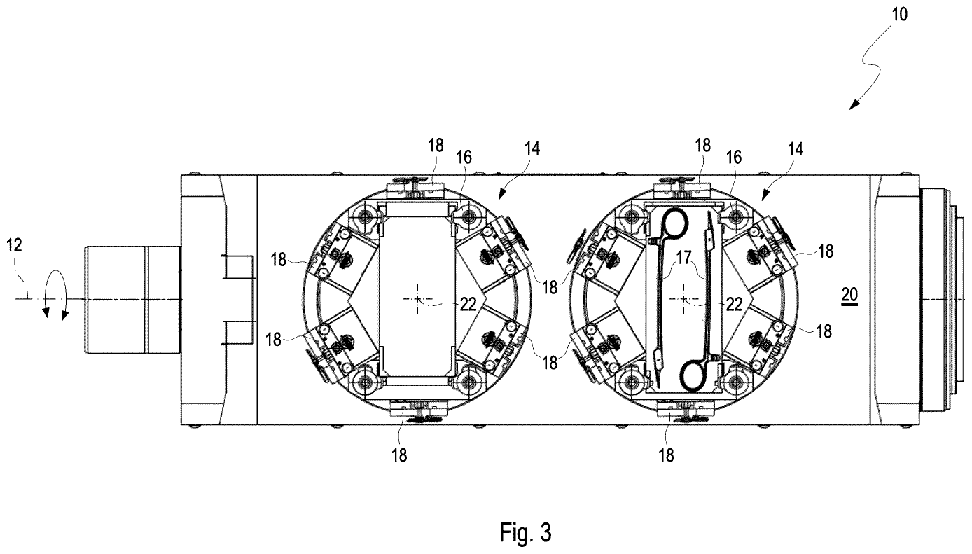

The workpiece holders 14 are only shown schematically in FIG. 1. In the following reference is made to the drawing according to FIGS. 2 and 3.

The workpiece holders 14 each comprise a first workpiece receptacle 16, on which a flat workpiece 17 can be attached for the machining of a flat side. In the exemplary embodiment shown in the figures each workpiece holder 14 comprises six second workpiece receptacles 18 that run transversely or obliquely to the first workpiece receptacle 16 and on which a flat workpiece 17 can be fixed for machining of a front side.

The workpiece tables 10 are fixed in such a way that they can be moved from a first working position, in which the first workpiece receptacle 16 is accessible to at least one of the at least one working spindles 6 for machining, by rotating or swivelling about the table axis 12 associated with the workpiece table 10, into at least one second working position in which the second workpiece receptacle 18 of at least one of the at least one working spindle 6 is accessible for machining.

In the exemplary embodiment of the machine tool 2 shown in the figures, each of the workpiece tables 10 includes a holding surface 20, on each of which two workpiece holders 14 are fixed. The holding surface 20 is arranged in the first working position transversely or obliquely to the spindle axis 8 or a working spindle 6 and in the second working position is arranged transversely or obliquely to the spindle axis 8 of the working spindle 6. The first workpiece receptacles 16 on the workpiece holder 14 run essentially parallel to the holding surface 20 of the workpiece table 10, on which the workpiece holder 14 is arranged and the second workpiece receptacles 18 essentially transverse or oblique to holding surface 20.

This makes it possible that a flat workpiece 17 arranged on the first workpiece receptacle 16 can be machined on its flat side in the first working position of the workpiece table 10 by a working spindle 6. This also makes it possible that, when the workpiece 10 is transferred in to the second working position, a flat workpiece 17 arranged on the second workpiece receptacle 18 can be machined on its front side by the working spindle 6.

The machine tool 2 is designed in such a way that each workpiece holder 14 can be rotated about a workpiece holder rotary axis 22 extending obliquely to the holding surface 20. This makes it possible that the workpiece holders 14 can be arranged in different machining positions. In a first machining position, in which the workpiece table 10 is arranged in the second working position, a first second workpiece receptacle 18 is facing the working spindle 6. Through rotation about the workpiece holder rotary axis 22, a second second workpiece receptacle 18 can be transferred to a second machining position, in which a flat tool 17 that is arranged on the second second workpiece receptacle 18 can be machined by the working spindle 6.

The machine tool 2 is designed in such a way that flat workpieces 17 that are arranged on the first workpiece receptacle 16 can be machined roughly and semi-finely (OP 10) by the working spindle 6 and flat workpieces 17 arranged on the second workpiece receptacle 18 are accessible for fine machining (OP 20) by the working spindle 6.

The figures show an embodiment of the machine tool 2 on which two workpiece tables 10 are provided. These are arranged to run parallel to one another and be spaced apart form one another with regard to their table axes 12. Both workpiece tables 10 are arranged so they can rotate about a mutual swivel support 24. The swivel support 24 is fixed, mounted on the machine frame 4 so it can rotate or swivel about a swivel axis 26.

This makes it possible that one of the workpiece tables 10 is arranged on a side facing at least one working spindle 6, forming a working area 28. On a side opposite the swivel axis 26, a further workpiece table 10 is arranged, arranged in a loading and unloading area 30. As a workpiece table 10 is always arranged in the work area 28 and can be machined by the working spindle 6 and a workpiece table 10 is arranged in the loading and unloading area 30, the workpiece table 10 arranged in the loading and unloading area 30 can be loaded and unloaded, while the workpieces 17 located in working area 28 are machined. This allows the loading and unloading of machine tool 2 in parallel to machining time.

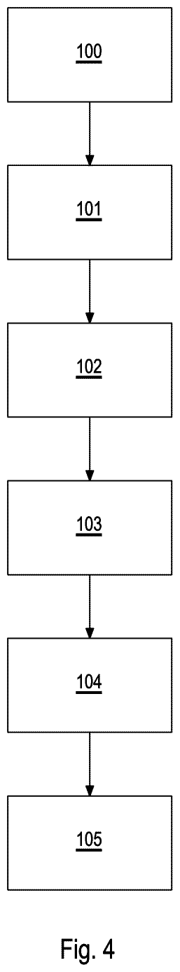

FIG. 4 shows a schematic flow chart of an embodiment of a process in accordance with the invention for the manufacture of flat instruments and/or tools for medical technology. With reference to the device shown in FIGS. 1 to 3, the process is described below:

In a step 100, at least one flat workpiece 17 is fixed on a first workpiece receptacle 16.

In parallel to or following this, a workpiece 17 that has already been machined on the first workpiece receptacle 16 can be fixed to one of the at least one second workpiece receptacle 18 in a step 101.

In a step 102, the workpiece table 10 is transferred to the first working position, in which the first workpiece receptacle 16 of the at least one working spindle 6 is accessible for machining. In the first working position the workpiece 17, which is fixed to the first workpiece receptacle 10, is machined by the working spindle 6.

If workpiece 17 has been machined on the first workpiece holder 16, in step 103 the workpiece table 10 is moved to the second working position, in which the second workpiece holder 18 is accessible to the at least one working spindle 6 for machining. In the second working position, the workpieces 17 fixed to the second workpiece holder 18 are then machined by the working spindle 6.

In a step 104 the workpiece holder 14 can be transferred from the first machining position into a further machining position. This is the case if several second workpiece receptacles 18 are provided with workpieces 17 arranged on them.

After this, in a final step 105, the workpieces 17 that have been machined on the second workpiece receptacle 18 and the workpieces 17 that have been machined on the first workpiece receptacle 16 can be removed.

With regard to the workpieces 17 machined on the first workpiece receptacle 16, this may include almost complete separation of the workpieces 17 from a raw material plate, for example manually or fully automatically using a robot. These workpieces 17 machined on the first workpiece holder 16 can then be secured directly or via a transfer station on the second workpiece receptacle 18 in a further step 101.

The features of the invention disclosed in the above description, in the claims and in the drawing may be essential for the realisation of the invention in its various embodiments, both individually and in any combination, within the scope of the following claims.

### REFERENCE SYMBOL LIST

2 Machine tool
4 Machine frame
6 Working spindle
8 Spindle axis
10 Workpiece table
12 Table axis
14 Workpiece holder
16 First workpiece receptacle
17 Workpiece
18 Second workpiece receptacle
20 Holding surface
22 Workpiece holder rotary axis
24 Swivel support
26 Swivel axis
28 Working area
30 Loading and unloading area

1. A machine tool for manufacturing flat instruments and/or tools with a machine
frame, the machine tool comprising:
at least one working spindle that is mounted so that it can rotate around a spindle axis,
at least one workpiece table that can be assigned or is assigned to at least one working spindle and is mounted directly or indirectly on the machine frame so that it can rotate or swivel around a table axis, and
at least one workpiece holder, which is fixed to the workpiece table, which has at least one first workpiece receptacle to which a flat workpiece can be fixed for machining a flat side, and which has at least one second workpiece receptacle, which runs transversely or obliquely to the first workpiece receptacle and to which a flat workpiece can be fixed for machining a front side,
wherein at least one of the at least one workpiece table can be transferred from a first working position, in which the first workpiece receptacle is accessible to at least one of the at least one working spindle for machining, by rotating or swivelling about the table axis assigned to it into a second working position, in which the second workpiece receptacle is accessible to at least one of the at least one working spindle for machining.

2. The machine tool according to claim 1, wherein at least one of the at least one workpiece table comprises a holding surface on which at least one of the at least one workpiece holder is arranged, and which is arranged in the first working position transversely or obliquely to the spindle axis of the working spindle assigned to the workpiece table, and that is arranged in the second working position transversely or obliquely to the spindle axis of the working spindle assigned to the workpiece table.

3. The machine tool according to claim 2, wherein the first workpiece receptacle of the workpiece holder runs parallel or obliquely to the holding surface of the workpiece table and that the flat workpiece fixed to the first workpiece receptacle can be machined by the working spindle on its flat side running parallel or obliquely to the holding surface and/or that the second workpiece receptacle of the workpiece holder runs transversely or obliquely to the holding surface of the workpiece table and that the flat workpiece fixed to the second workpiece receptacle can be machined by the working spindle on its front side of the workpiece running transversely or obliquely to the holding surface.

4. The machine tool according to claim 2, wherein the first workpiece receptacle is arranged on a head surface of the workpiece holder which runs parallel or obliquely to the holding surface and is spaced apart from the holding surface, and in that at least one of the at least one second workpiece receptacle is arranged on a side surface arranged between the holding surface and the head surface and running transversely or obliquely to the holding surface.

5. The machine tool according to claim 1, wherein at least one of the at least one workpiece holder has at least two second workpiece receptacles, each of which runs transversely or obliquely to the first workpiece receptacle, and in that the workpiece holder comprises at least one workpiece holder drive, by means of which the workpiece holder is moved, at least in the second working position of the workpiece table relative to the workpiece table from a first machining position, in which a first second workpiece receptacle is accessible to the working spindle, into at least one further machining position, in which a further second workpiece receptacle is accessible to the working spindle.

6. The machine tool according to claim 1, wherein at least one of the at least one workpiece holder is fixed to the holding surface of the workpiece table so that it can rotate about a workpiece holder rotary axis extending transversely to the holding surface of the workpiece table.

7. The machine tool according to claim 6, wherein the transfer from the first machining position to the second machining position by the workpiece holder drive comprises rotating or swivelling of the workpiece holder about the workpiece holder rotary axis.

8. The machine tool according to claim 1, wherein at least one of the at least one first workpiece receptacles fixes a flat workpiece fixed to it for rough and semi-fine machining by the at least one working spindle and/or if at least one of the at least one second workpiece holder fixes a flat workpiece fixed to it for fine machining by the at least one working spindle.

9. The machine tool according to claim 1, wherein in that at least two workpiece holders are arranged on a workpiece table, which are arranged at a distance from each other on the same holding surface, and in particular that the at least one working spindle comprises at least one first working spindle, which is assigned to a first workpiece holder of the at least two workpiece holders, and at least one further working spindle, which is assigned to a further workpiece holder of the at least two workpiece holders.

10. The machine tool according to claim 1, wherein the at least one workpiece table comprises at least two workpiece tables, wherein a first workpiece table can be rotated or swivelled about a first table axis wherein a second workpiece table can be rotated or swivelled about a second table axis without touching the first workpiece table and wherein the first table axis and the second table axis run parallel to one another.

11. The machine tool according to claim 1, wherein the at least one workpiece table is mounted on a swivel support so as to rotate or swivel, wherein the swivel support is mounted on the machine frame so as to rotate or swivel about a swivel axis and can be transferred from a first swivel position, in which at least one of the at least on workpiece tables can be arranged in a working area facing a working spindle, into a second swivel position, in which the workpiece table is arranged in a loading and unloading area.

12. The machine tool according to claim 11, wherein the at least two workpiece tables are arranged on opposite sides of the swivel support, wherein at least one first workpiece table is arranged in the working area in the first swivel position of the swivel support and at least one second workpiece table is arranged in the loading and unloading area in the first swivel position of the swivel support, and wherein the at least one first workpiece table is arranged in the loading and unloading area in the second swivel position of the swivel support and the at least one second workpiece table is arranged in the second swivel position of the swivel support in the working area.

13. The machine tool according to claim 1, wherein the swivel support axis, the at least one first table axis and/or the at least one second table axis run parallel to a horizontally extending x-axis, and in particular parallel to each other, or that the swivel support axis, the at least one first table axis and/or the at least one second table axis run parallel to a vertically extending y-axis, and in particular parallel to each other.

14. The machine tool according to claim 9, wherein the first working spindle and the at least one further working spindle are arranged horizontally next to each other when the at least one table axis, in particular the first table axis, runs parallel to the horizontally extending x-axis, and that the first working spindle and the at least one further working spindle are arranged vertically above one another when the at least one table axis, in particular the first table axis, runs parallel to the vertically extending y-axis.

15. The process for the manufacture of flat instruments and/or tools for medical technology with a machine tool with claim 1, with the steps:
a. fixing a flat workpiece on the at least one first workpiece receptacle;
b. fixing at least one workpiece that has already been machined on the first workpiece receptacle to one of the at least one second workpiece receptacle;
c. transferring the workpiece table into the first working position, in which the first workpiece receptacle of the at least one working spindle is accessible for machining, and machining of the first workpiece fixed to the first workpiece receptacle by the working spindle;
d. transferring the workpiece table into the second working position, in which the second workpiece receptacle of the at least one working spindle is accessible for machining, and machining of the workpiece fixed to the second workpiece receptacle by the working spindle;
e. if necessary, transferring the workpiece holder from the first machining position to a further machining position;
f. removing the at least one workpiece machined on the second workpiece receptacle and removal of the at least one workpiece machined on the first workpiece receptacle.
